(19) United States
(12) Patent Application Publication
(10) Pub. No.: US 2020/0129854 A1
(43) Pub. Date: Apr. 30, 2020

(54) Haptic Safety Harness

(71) Applicant: Immersion Corporation, San Jose, CA (US)

(72) Inventor: William S. Rihn, San Jose, CA (US)

(21) Appl. No.: 16/170,991

(22) Filed: Oct. 25, 2018

(51) Int. Cl. A63F 13/285; G08B 6/00; A41D 1/00; A63F 13/212

(52) U.S. Cl. CPC A63F 13/285; A63F 13/212; A41D 1/002; G08B 6/00

(57) ABSTRACT

The present invention provides a haptic system including a haptic safety harness worn by a user and a haptic support structure. The haptic safety harness includes an adjustable belt with magnets. The haptic support structure includes an upper platform, a lower platform on which the user stands, and a communication interface. The upper platform includes electromagnets and has an annular shape that defines an inner space in which the haptic safety harness is disposed. The communication interface is coupled to the electromagnets, and is configured to receive a haptic control signal from a computer and transmit the haptic control signal to the electromagnets. The haptic control signal is configured to render a haptic effect to the user by generating a magnetic field that interacts with the magnets.

### TECHNICAL FIELD

The present invention relates to a safety harness. More particularly, the present invention relates to a haptic safety harness.

### BACKGROUND

Electronic gaming devices, such as personal computers, home video game consoles, handheld video game consoles, etc., typically use visual and auditory cues to provide feedback to a user. In some electronic devices, tactile feedback and/or kinesthetic feedback may be provided to the user. Tactile feedback is known as “tactile haptic feedback” or “tactile haptic effects,” and may include, for example, vibration, texture, temperature variation, etc. Kinesthetic feedback is known as “kinesthetic haptic feedback” or “kinesthetic haptic effects,” and may include, for example, active and resistive force feedback. In general, tactile and kinesthetic feedback are collectively known as “haptic feedback” or “haptic effects.” Haptic effects provide cues that enhance a user's interaction with an electronic device, from augmenting simple alerts to specific events to creating a greater sensory immersion for the user within a computer-generated environment, such as an augmented reality (AR) environment or a virtual reality (VR) environment.

In certain AR and VR environments, a locomotion platform or omnidirectional treadmill (ODT) allows a user to simulate movement in one, two or three dimensions. The ODT includes a lower platform, an upper ring and several support members that connect the lower platform to the upper ring. The user stands on the lower platform and within the upper ring, and wears a safety harness around the waist that is connected to the upper ring using straps, cables, carabiners, etc. The support members may be fixed in place, or the support members may allow the user to move the upper ring with respect to the lower platform. At most, an ODT may provide a vibratory haptic effect to the user's feet by vibrating the lower platform.

### SUMMARY

Embodiments of the present invention advantageously provide a haptic system including a haptic safety harness worn by a user and a haptic support structure coupled to the haptic safety harness. The haptic safety harness includes an adjustable belt with magnets. The haptic support structure includes an upper platform, a lower platform on which the user stands, and a communication interface. Support members couple the lower platform to the upper platform. The upper platform includes electromagnets and has an annular shape that defines an inner space in which the haptic safety harness is disposed. The communication interface is coupled to the electromagnets, and is configured to receive a haptic control signal from a computer and transmit the haptic control signal to the electromagnets. The haptic control signal is configured to render a haptic effect to the user by generating a magnetic field that interacts with the magnets.

### BRIEF DESCRIPTION OF THE DRAWINGS

FIG. 1 illustrates a block diagram of a system, in accordance with an embodiment of the present invention.

FIG. 2 depicts a front view of a haptic safety harness, in accordance with an embodiment of the present invention.

FIG. 3 depicts a top view of the haptic safety harness of FIG. 2, in accordance with an embodiment of the present invention.

FIG. 4 depicts a front view of a haptic support structure for use with the haptic safety harness of FIGS. 2 and 3, in accordance with an embodiment of the present invention.

FIG. 5 depicts a top view of the haptic support structure of FIG. 4, in accordance with an embodiment of the present invention.

FIGS. 6A, 6B and 6C depict haptic effects generated by a haptic system, in accordance with an embodiment of the present invention.

FIG. 7 depicts a front view of a safety harness, in accordance with an embodiment of the present invention.

### DETAILED DESCRIPTION

Embodiments of the present invention will now be described with reference to the drawing figures, in which like reference numerals refer to like parts throughout.

Embodiments of the present invention advantageously provide a haptic safety harness worn by a user, a haptic system that includes the haptic safety harness worn by a user and a haptic support structure, and a safety harness worn by a user.

One example of the haptic safety harness worn by a user includes an adjustable belt with a first set of magnets. The first set of magnets interacts with a magnetic field generated by a first set of electromagnets to render a haptic effect to the user. Another example of the haptic safety harness includes an adjustable belt with a first set of magnets and a second set of magnets oriented perpendicular to the first set of magnets. The second set of magnets interacts with a magnetic field generated by a second set of electromagnets to render a haptic effect to the user.

In the haptic system, the haptic safety harness is coupled to the haptic support structure which includes an upper platform, a lower platform on which the user stands, and a communication interface. The upper platform has an annular shape that defines an inner space in which the haptic safety harness is disposed. The lower platform is coupled to the upper platform by support members, and the communication interface receives a haptic control signal from a computer.

One example of the upper platform includes a first set of electromagnets. The communication interface transmits the haptic control signal to the first set of electromagnets. The haptic control signal is configured to render a haptic effect to the user by generating a magnetic field that interacts with a first set of magnets in the haptic safety harness.

Another example of the upper platform includes a first set of electromagnets and a second set of electromagnets oriented perpendicular to the first set of electromagnets. The communication interface transmits an additional haptic control signal to the second set of electromagnets. The additional haptic control signal is configured to render an additional haptic effect to the user by generating an additional magnetic field that interacts with a second set of magnets oriented perpendicular to a first set of magnets in the haptic safety harness. In this example, the haptic control signal and the additional haptic control signal may be sent to the respective electromagnets at different times or at the same time. In the latter case, the haptic control signal and the additional haptic control signal are configured to simultaneously render the haptic effect and the additional haptic effect by simultaneously generating the magnetic field and the additional magnetic field.

One example of the safety harness includes an adjustable belt, a pair of adjustable leg straps, and a sensor interface coupled to a sensor. The adjustable belt and the adjustable leg straps include smart material. The sensor interface is coupled to the smart material and is configured measure a tension of a line, such as a rappel rope or line, and tighten or loosen the adjustable belt, the first adjustable leg strap and the second adjustable leg strap based on the tension of the line by activating or deactivating the smart material in the adjustable belt, the first adjustable leg strap and the second adjustable leg strap, respectively. Another example of the safety harness also includes an adjustable shoulder harness that is coupled to the adjustable belt. The shoulder harness also includes smart material, which is coupled to the sensor interface.

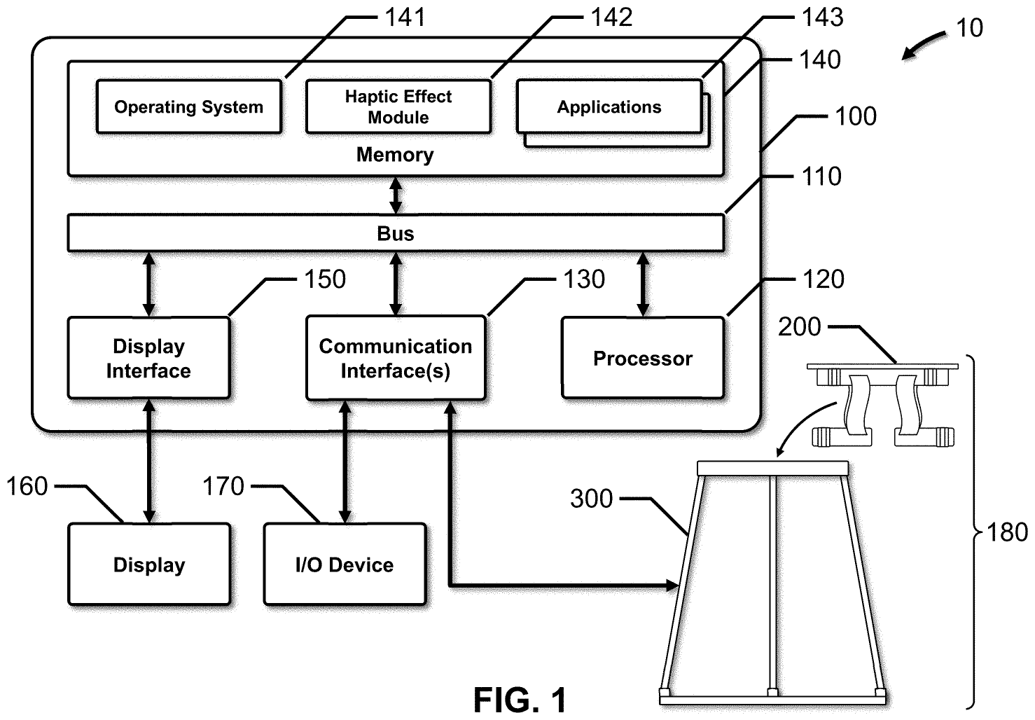

FIG. 1 illustrates a block diagram of a system 10, in accordance with an embodiment of the present invention.

System 10 includes computer 100, display 160, input/output device 170, and haptic system 180. Computer 100 may be a personal computer, a laptop computer, a game console, etc. Display 160 may be a liquid crystal display (LCD) monitor, an LCD television, virtual reality headset, etc. Input/output device 170 may be a game controller, a data glove, etc. Haptic system 180 includes haptic safety harness 200 and haptic support structure 300. On one example, haptic system 180 may be an omnidirectional treadmill used for virtual reality applications.

Computer 100 includes bus 110, one or more processors 120, communication interface 130, memory 140 and display interface 150. Communication interface 130 is coupled to input/output device 170 and haptic system 180, and display interface 150 is coupled to display 160. Generally, bus 110 is a communication system that transfers data between processor 120, communication interface 130, memory 140 and display interface 150, as well as other components not depicted in FIG. 1.

Processor 120 includes one or more general-purpose or application-specific microprocessors to perform computation and control functions for computer 100. Processor 120 may include a single integrated circuit, such as a micro-processing device, or multiple integrated circuit devices and/or circuit boards working in cooperation to accomplish the functions of processor 120. In addition, processor 120 may execute computer programs, such as operating system 141, haptic effect module 142, applications 143, etc., stored within memory 140.

Communication interface 130 is configured to transmit and/or receive data from input/output device 170 and haptic system 180. Communication interface 130 enables connectivity between processor 120, input/output device 170 and haptic system 180 by encoding data to be sent from processor 120 to input/output device 170 and haptic system 180, and decoding data received from input/output device 170 and haptic system 180 for processor 120. Data may be sent over a wired connection or a wireless connection.

For example, communication interface 130 may include a wireless interface card that is configured to provide a wireless connection. A variety of wireless communication techniques may be used including infrared, radio, Bluetooth, Wi-Fi, etc. Alternatively, communication interface 130 may be configured to provide a wired connection, such as a Universal Serial Bus (USB) connection, Ethernet, etc.

Memory 140 stores information and instructions for execution by processor 120. Memory 140 may contain various components for retrieving, presenting, modifying, and storing data. For example, memory 140 may store software modules that provide functionality when executed by processor 120. The modules may include an operating system 141 that provides operating system functionality for computer 100. The modules may also include haptic effect module 142 that generates a haptic control signal configured to render a haptic effect at haptic system 180. In certain embodiments, haptic effect module 142 may include a plurality of modules, each module providing specific individual functionality for generating a haptic effect experienced at haptic system 180. The modules may also include one or more application 143 that provide additional functionality, such as video games, virtual reality applications, etc.

Generally, memory 140 may include a variety of non-transitory computer-readable medium that may be accessed by processor 120. In the various embodiments, memory 140 may include volatile and nonvolatile medium, non-removable medium and/or removable medium. For example, memory 140 may include any combination of random access memory (“RAM”), dynamic RAM (DRAM), static RAM (SRAM), read only memory (“ROM”), flash memory, cache memory, and/or any other type of non-transitory computer-readable medium.

Input/output device 170 is an optional peripheral device configured to provide input to computer 100 and may optionally provide haptic feedback to the user. As noted above, input/output device 170 may be operably connected to computer 100 using either a wireless connection or a wired connection. Input/output device 170 may also include a local processor configured to communicate with computer 100 using the wireless connection or wired connection.

Input/output device 170 may include one or more digital buttons, one or more analog buttons, one or more bumpers, one or more directional pads, one or more analog or digital sticks, one or more driving wheels, and/or one or more user input elements that can be interacted with by a user, and that can provide input to computer 100. As is described below in greater detail, input/output device 170 also includes one or more analog or digital trigger buttons that provide input to computer 100 from the user.

Generally, input/output device 170 may include one or more haptic actuators. The local processor of input/output device 170, or processor 120 in embodiments where input/output device 170 does not include a local processor, may transmit a haptic signal associated with a haptic effect to at least one haptic actuator of input/output device 170. The haptic actuator, in turn, outputs haptic effects such as vibrotactile haptic effects, kinesthetic haptic effects, or deformation haptic effects, in response to the haptic signal. The haptic effects can be experienced at a user input element, such as, for example, a trigger, a digital button, analog button, bumper, directional pad, analog or digital stick, driving wheel, etc., of input/output device 170. Additionally, the haptic effects can be experienced at an outer surface of input/output device 170.

The haptic actuator may be, for example, an electric motor, an electromagnetic actuator, a voice coil, a shape memory alloy, an electro-active polymer, a solenoid, an eccentric rotating mass motor (“ERM”), a harmonic ERM motor (“HERM”), a linear actuator, a linear resonant actuator (“LRA”), a piezoelectric actuator, a high bandwidth actuator, an electroactive polymer (“EAP”) actuator, an electrostatic friction display, an ultrasonic vibration generator, etc. In some instances, the haptic actuator may include an actuator drive circuit.

Input/output device 170 can further include one or more sensors. A sensor may be configured to detect a form of energy, or other physical property, such as, but not limited to, sound, movement, acceleration, bio signals, distance, flow, force/pressure/strain/bend, humidity, linear position, orientation/inclination, radio frequency, rotary position, rotary velocity, manipulation of a switch, temperature, vibration, or visible light intensity. The sensor may further be configured to convert the detected energy, or other physical property, into an electrical signal, or any signal that represents virtual sensor information, and input/output device 170 can send the converted signal to the local processor of input/output device 170, or processor 120 in embodiments where input/output device 170 does not include a local processor.

In many embodiments, input/output device 170 is a controller, such as, for example, a game controller.

Haptic system 180 includes haptic safety harness 200 and haptic support structure 300, discussed in more detail below.

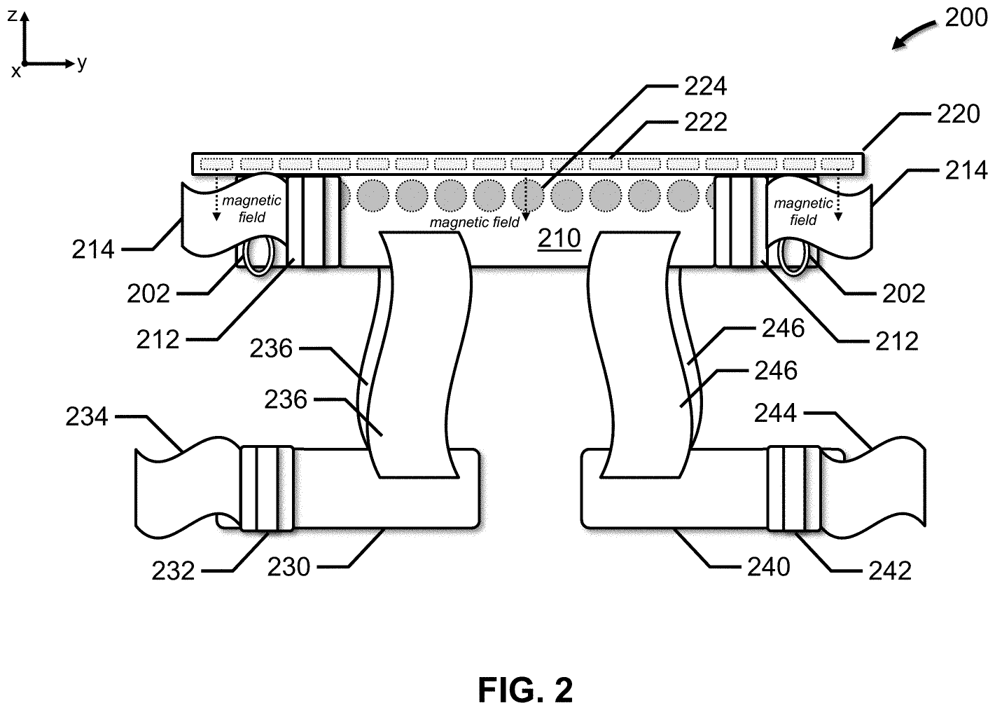

FIG. 2 depicts a front view of haptic safety harness 200, in accordance with an embodiment of the present invention. The x-y-z coordinate system depicted in FIG. 2 is for illustration purposes only.

Haptic safety harness 200 includes an adjustable belt 210 which includes one or more buckles 212 and adjustment straps 214 which cooperate to tighten adjustable belt 210 around the user's waist. Adjustable belt 210 has an annular shape that conforms to the user's waist and includes inner surface 216 that defines inner space 218. In one example, mechanical couplings 202 couple haptic safety harness 200 to haptic support structure 300. Mechanical couplings 202 may be carabiners, wire cables, flexible straps, etc. In another example, a magnetic repulsion coupling may be used to couple haptic safety harness 200 to haptic support structure 300.

Generally, mechanical couplings 202 or the electromagnetic repulsion coupling supports the weight of the user while providing a certain freedom of movement with the confines of haptic support structure 300. For example, mechanical couplings 202 may be attached to haptic support structure 300 in such a manner as to allow the user to rotate 360°, the electromagnetic repulsion coupling may be controlled to allow the user to rotate 360°, etc.

In one example of the haptic safety harness 200, a pair of adjustable leg straps 230, 240 are connected to adjustable belt 210 via straps 236, 246. Buckles 232, 242 and adjustment straps 234, 244 cooperate to tighten adjustable leg straps 230, 240 around the user's legs. In another example, an adjustable shoulder strap (not shown) may be connected to adjustable belt 210 to provide additional support. In a further example, only adjustable belt 210 may be provided.

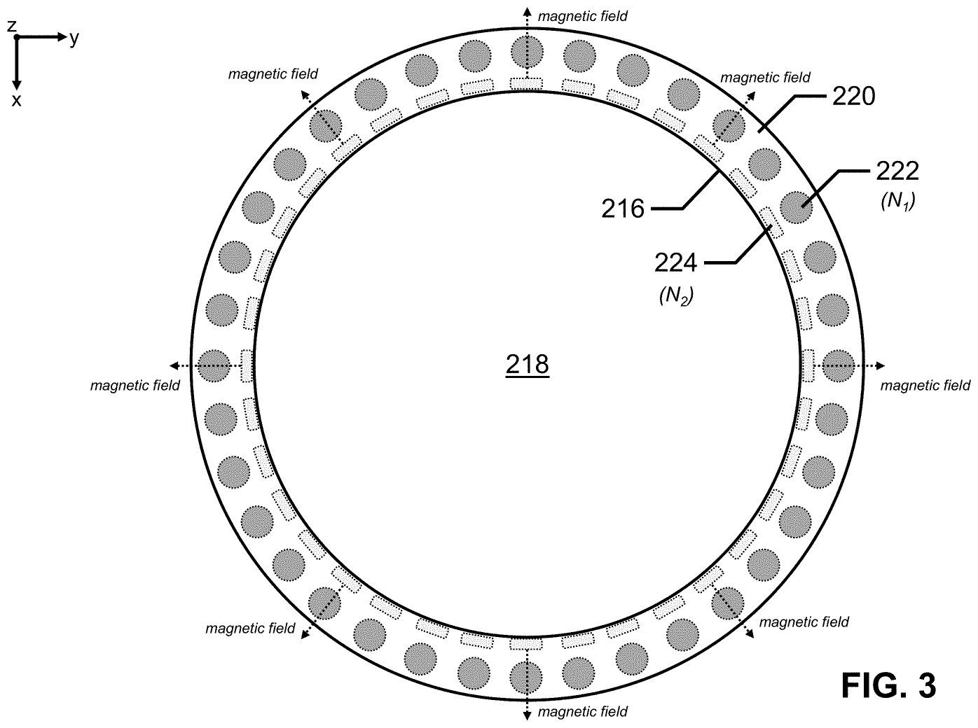

FIG. 3 depicts a top view of haptic safety harness 200 depicted in FIG. 2. The x-y-z coordinate system depicted in FIG. 3 is for illustration purposes only.

In one example of haptic safety harness 200, adjustable belt 210 includes upper surface 220 with magnets 222. The respective magnetic fields of magnets 222 are oriented in the same direction, such as, for example, along the z axis depicted in FIG. 2. Magnetic fields are depicted in FIG. 2 for several representative magnets 222; the remaining magnetic fields are not depicted in the interest of clarity. Magnets 222 may be permanent magnets, made from materials such as rare earth elements, ferromagnetic elements, ceramic composites, etc. Alternatively, magnets 222 may be electromagnets which require a power source, such as, for example, a battery attached to haptic safety harness 200, an external power supply electrically coupled to haptic safety harness 200 by a cable or wire, etc. Generally, N₁ magnets 222 are provided in upper surface 220. In one example, N₁ is 36, and magnets 222 are evenly distributed at 10° intervals around upper surface 220.

In another example of haptic safety harness 200, adjustable belt 210 includes magnets 224. The respective magnetic fields of magnets 224 are oriented in the same direction, such as, for example, radially to/from the center of inner space 218 depicted in FIG. 3. Magnetic fields are depicted in FIG. 2 for several magnets 224; the remaining magnetic fields are not depicted in the interest of clarity. Magnets 224 may be permanent magnets, made from materials such as rare earth elements, ferromagnetic elements, ceramic composites, etc. Alternatively, magnets 224 may be electromagnets which require a power source, such as, for example, a battery attached to haptic safety harness 200, an external power supply electrically coupled to haptic safety harness 200 by a cable or wire, etc. Generally, N₂ magnets 224 are provided in adjustable belt 210. In one example, N₂ is 36, and magnets 224 are evenly distributed at 10° intervals around adjustable belt 210.

In a further example of haptic safety harness 200, adjustable belt 210 includes magnets 222 and magnets 224.

In an embodiment that may be combined with the examples discussed above, haptic safety harness 200 may include a communication module (not shown). Data may be sent over a wired connection or a wireless connection, as discussed above. Power may be provided by a battery attached to haptic safety harness 200, an external power supply electrically coupled to haptic safety harness 200 by a cable or wire, etc.

In one example, haptic safety harness 200 may include one or more sensors (described above) coupled to the communications module. Sensor data may be acquired and transmitted to computer 100 and used as feedback.

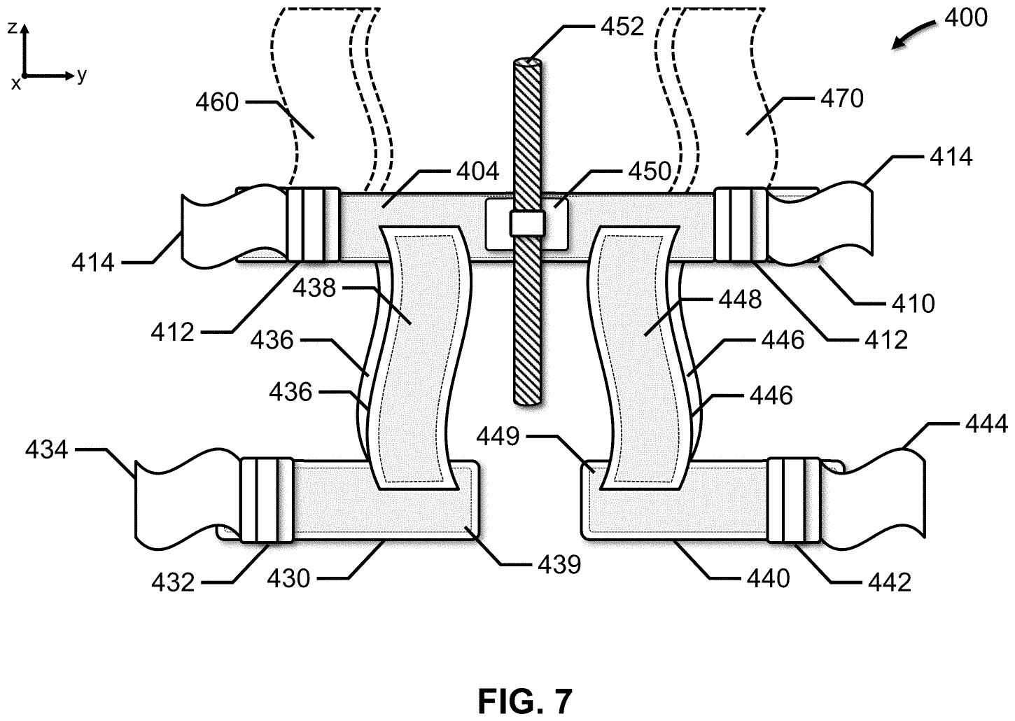

In another example, adjustable belt 210 and adjustable leg straps 230, 240 may include smart material coupled to the communication module, such as, for example, in a manner similar to the embodiment depicted in FIG. 7. Generally, smart material deforms in response to an electrical stimulus. In response to receiving a safety control signal, the communication module electrically activates the smart material, which becomes rigid to advantageously reduce the magnitude, strength, force, etc. of the haptic effect rendered to the user. The safety control signal may be received from the user via a dedicated button or switch on haptic safety harness 200, input/output device 170, etc.

Examples of smart material include shape memory alloys (such as temperature and magnetic shape-memory alloys), electroactive polymers having an electronic mechanism (such as electrostrictive, electrostatic, piezoelectric, and ferroelectric polymers), piezoelectric materials including piezo-polymers, conductive polymers, cellulose and other biopolymers, ionic polymer metal composites (IPMC), electrorheostatic materials, magnetorheostatic materials, magnetostrictive materials, pH-sensitive polymers, Peltier cells, ferrofluidic materials, and other fluidic materials. Additionally the smart material can be formed with or otherwise include nanoparticles or nanotubes. Examples of smart polymers include polyvinylidene fluoride (PVDF), polylactic acid (PLA), homo-polymers, co-polymers, and ter-polymers. The smart materials also can include polymer-metal composites and other combinations of different materials. Other examples include smart materials that move or change shape in response to forces such as temperature, electric currents, electric fields, Coulomb forces, mobility or diffusion of ions.

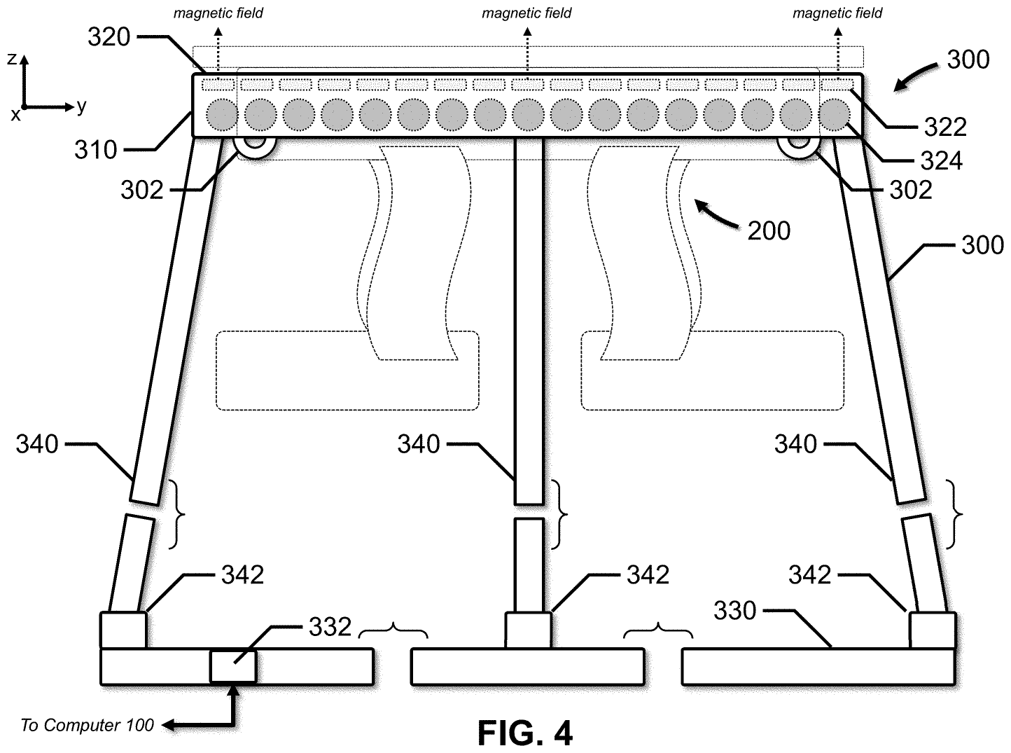

FIG. 4 depicts a front view of haptic support structure 300 for use with haptic safety harness 200 of FIGS. 2 and 3, in accordance with an embodiment of the present invention. The x-y-z coordinate system depicted in FIG. 4 is for illustration purposes only.

Haptic support structure 300 includes upper platform 310, lower platform 330, support members 340, and communication interface 332. The user stands on lower platform 330, which is coupled to upper platform 310 by support members 340. Support members 340 may be rigidly connected to upper platform 310 and lower platform 330 to prevent movement between these platforms. Alternatively, support members 340 may be flexibly connected to upper platform 310 and lower platform 330 to allow movement of upper platform 310 with respect to lower platform 330. In one example, actuators 342 may be located at the base of support members 340 to effectuate this movement. In another example, support members 340 and actuators 342 may be translatable within fixed support pylons, allowing upper platform 310 to move in the z direction as well as rotate about the x and y axes. In one example, haptic support structure 300 is an omnidirectional virtual reality treadmill.

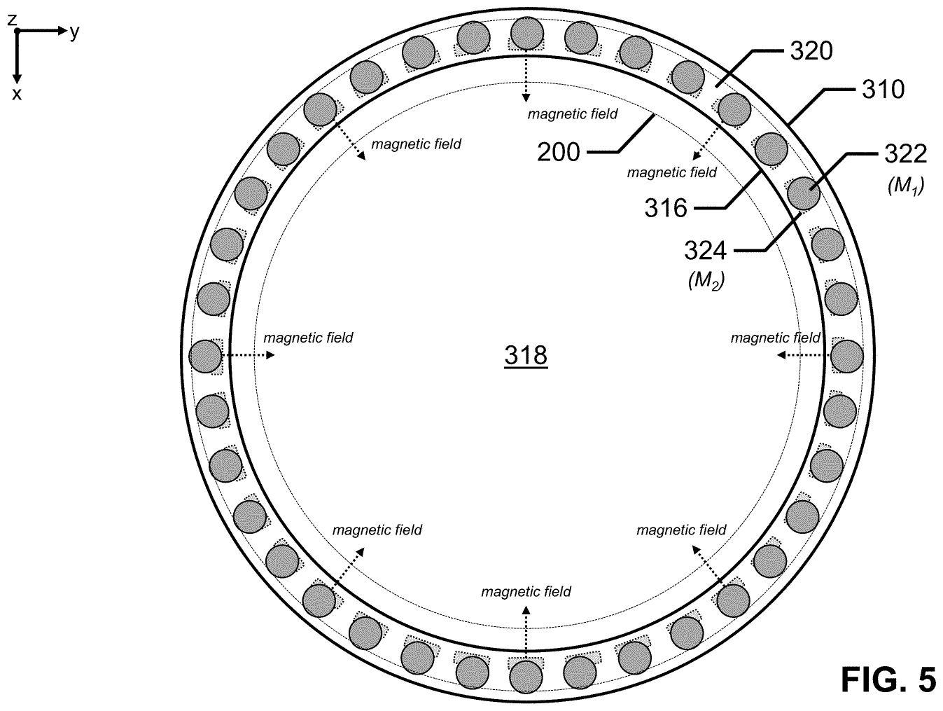

Referring briefly to FIG. 5, upper platform 310 has an annular shape with inner surface 316 that defines inner space 318 in which the user wearing haptic safety harness 200 is disposed. In one example, mechanical couplings 302 cooperate with mechanical couplings 202 to couple haptic safety harness 200 to haptic support structure 300. Mechanical couplings 302 may be eye bolts, wire cables, flexible straps, etc., that may be rigidly attached to upper platform 310 to prevent rotational motion of haptic safety harness 200. Alternatively, mechanical couplings 302 bay be attached to upper platform 310 to allow rotational motion of haptic safety harness 200, such as, for example, a rolling element bearing that has an inner race, and outer race and a set of ball bearings. The rolling element bearing may be mounted to a lower surface of upper platform 310. Mechanical couplings 302 depend from the inner race, which provides 360° of rotational freedom. In another example, a magnetic repulsion coupling may be used to connect haptic safety harness 200 to haptic support structure 300.

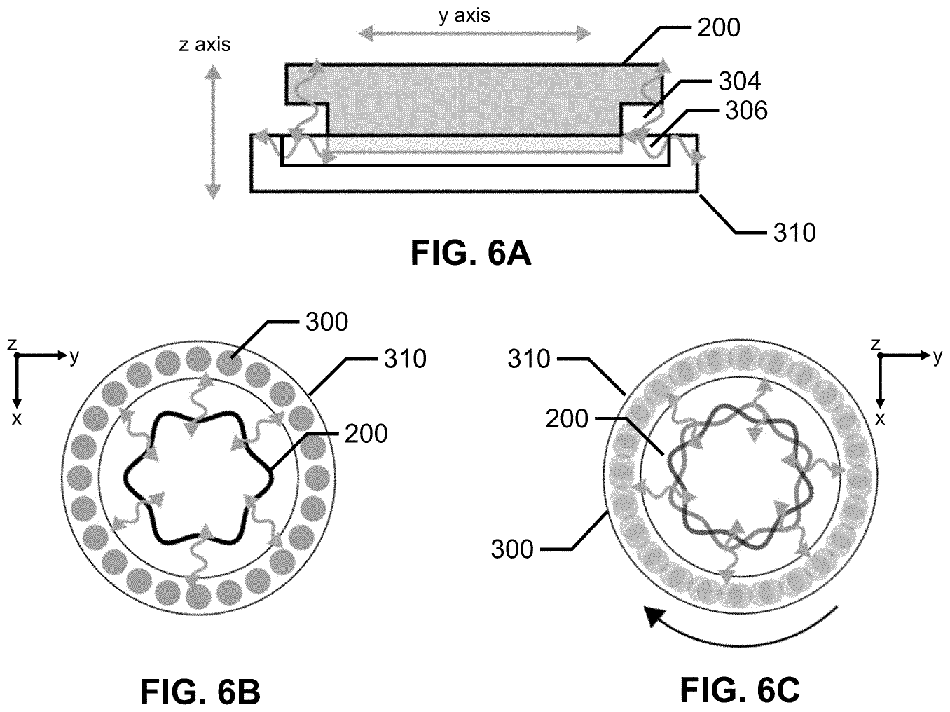

Referring briefly to FIG. 6A, when haptic safety harness 200 is worn by the user and coupled to haptic support structure 300, the mechanical or magnetic repulsion couplings provide air gap 304 and air gap 306 between haptic safety harness 200 and haptic support structure 300. Air gap 304 is disposed between upper surface 220 and upper surface 320, and air gap 306 is disposed between adjustable belt 210 and inner surface 316. Preferably, haptic safety harness 200 and haptic support structure 300 do not contact one another. Alternatively, some contact may be accommodated.

FIG. 5 depicts a top view of haptic support structure 300 depicted in FIG. 4. A top view of haptic safety harness 200 is also depicted in broken line. The x-y-z coordinate system depicted in FIG. 5 is for illustration purposes only.

In one example of haptic support structure 300, upper platform 310 includes upper surface 320 with electromagnets 322. The respective magnetic fields of electromagnets 322 are oriented in the same direction, such as, for example, along the z axis depicted in FIG. 4. Magnetic fields are depicted in FIG. 4 for several representative electromagnets 322; the remaining magnetic fields are not depicted in the interest of clarity. Generally, M₁ electromagnets 322 are provided in upper surface 320. In one example, M₁ is 36, and electromagnets 322 are evenly distributed at 10° intervals around upper surface 320.

In another example of haptic support structure 300, upper platform 310 includes electromagnets 324. The respective magnetic fields of electromagnets 324 are oriented in the same direction, such as, for example, radially to/from the center of inner space 318 depicted in FIG. 5. Magnetic fields are depicted in FIG. 4 for several electromagnets 324; the remaining magnetic fields are not depicted in the interest of clarity. Generally, M₂ electromagnets 324 are provided in upper platform 310. In one example, M₂ is 36, and electromagnets 324 are evenly distributed at 10° intervals around inner surface 316.

In a further example of haptic support structure 300, upper platform 310 includes electromagnets 322 and electromagnets 324.

In one example, communication interface 332 is configured to receive a haptic control signal from computer 100, and transmit the haptic control signal to electromagnets 322. The haptic control signal is configured to render a haptic effect to the user by generating a magnetic field, using electromagnets 322, that interacts with magnets 222. The haptic effect may be a vibratory haptic effect, a force feedback haptic effect, etc. The magnetic repulsion coupling discussed above may be created by applying a constant, baseline signal to electromagnets 322, which remain energized to provide a force in the +z direction to support the haptic safety harness and the user. The baseline signal may be adjusted to each user's weight, and the haptic control signal is simply added to the baseline signal.

To render a vibratory haptic effect, the haptic control signal may be a time-varying signal that simultaneously energizes each of the electromagnets 322, which produces a time-varying movement of the haptic safety harness 200 in the +/−z direction. Alternatively, the haptic control signal may be a time-varying signal that energizes a subset of electromagnets 322, which produces a time-varying, but localized, movement of the haptic safety harness 200 in the +/−z direction. The haptic control signal may also be a time-varying signal that sequentially energizes each of the electromagnets 322, which produces a rotating magnetic field and a time-varying movement of the haptic safety harness 200 in the +/−z direction or rotation about the z axis.

To render a force feedback haptic effect, the haptic control signal may be a signal that simultaneously energizes each of the electromagnets 322, which produces a fixed movement of the haptic safety harness 200 in the +/−z direction. Alternatively, the haptic control signal may be a signal that energizes a subset of electromagnets 322, which produces a localized movement of the haptic safety harness 200 in the +/−z direction.

In these examples, electromagnets 322 are rigidly attached to upper surface 320. In another example, electromagnets 322 are replaced by permanent magnets (not shown) that may be attached to upper surface 320 to allow rotation in one, two or three axes. In this example, the haptic control signal controls the rotation of the permanent magnets, rather than the magnetic field strength, in order to generate the time-varying magnetic field to render the haptic effect to the user.

In another example, communication interface 332 is configured to receive a haptic control signal from computer 100, and transmit the haptic control signal to electromagnets 324. The haptic control signal is configured to render a haptic effect to the user by generating a magnetic field, using electromagnets 324, that interacts with magnets 224. The haptic effect may be a vibratory haptic effect, a force feedback haptic effect, etc.

To render a vibratory haptic effect, the haptic control signal may be a time-varying signal that simultaneously energizes each of the electromagnets 324, which produces a time-varying movement of the haptic safety harness 200 in the x-y plane. Alternatively, the haptic control signal may be a time-varying signal that energizes a subset of electromagnets 324, which produces a time-varying, but localized, movement of the haptic safety harness 200 in the x-y plane. The haptic control signal may also be a time-varying signal that sequentially energizes each of the electromagnets 324, which produces a rotating magnetic field and a time-varying movement of the haptic safety harness 200 in the x-y plane or rotation about the z axis.

To render a force feedback haptic effect, the haptic control signal may be a signal that simultaneously energizes each of the electromagnets 324, which produces a fixed movement of the haptic safety harness 200 in the x-y plane. Alternatively, the haptic control signal may be a signal that energizes a subset of electromagnets 324, which produces a localized movement of the haptic safety harness 200 in the x-y plane.

In these examples, electromagnets 324 are rigidly attached to upper platform 310. In another example, electromagnets 324 are replaced by permanent magnets (not shown) that may be attached to upper platform 310 to allow rotation in one, two or three axes. In this example, the haptic control signal controls the rotation of the permanent magnets, rather than the magnetic field strength, in order to generate the time-varying magnetic field to render the haptic effect to the user.

Corresponding to the examples mentioned above, communication interface 332 may be coupled to electromagnets 322, communication interface 332 may be coupled to electromagnets 324, or communication interface 332 may be coupled to electromagnets 322 and electromagnets 324. When communication interface 332 is coupled to electromagnets 322 and electromagnets 324, in one example, two haptic control signals may be received; one haptic control signal is transmitted to electromagnets 322, and the other haptic control signal is transmitted to electromagnets 324. These haptic control signals may be transmitted to their respective electromagnets simultaneously, sequentially, or in an overlapping manner. Alternatively, a single haptic control signal may be received, processed, and then individual haptic controls signals may be transmitted to electromagnets 322 and electromagnets 324 simultaneously, sequentially, or in an overlapping manner.

FIGS. 6A, 6B and 6C depict haptic effects generated by haptic system 180, in accordance with an embodiment of the present invention.

In FIG. 6A, haptic effects generated in the z direction and the y direction are depicted. In FIG. 6B, a haptic effect generated in the x-y plane is depicted. The haptic effect has deformed adjustable belt 210 into a complex shape using a subset of electromagnets 324. The deformation may be time-varying for a vibratory haptic effect, or constant for a force feedback haptic effect. In FIG. 6C, a haptic effect generated in the x-y plane is depicted. The haptic effect has deformed adjustable belt 210 into a complex shape that is changing over time using, for example, a rotating magnetic field generated by electromagnets 322 and/or electromagnets 324. When the rotating magnetic field velocity exceeds a certain threshold, a texture may be rendered as the haptic effect.

Generally, the haptic effects rendered by haptic system 180 can turn, lift, lower and tilt the user using magnets 224 and electromagnets 324.

FIG. 7 depicts a front view of safety harness 400, in accordance with an embodiment of the present invention. The x-y-z coordinate system depicted in FIG. 7 is for illustration purposes only.

Safety harness 400 includes an adjustable belt 410 which includes one or more buckles 412 and adjustment straps 414 which cooperate to tighten adjustable belt 410 around the user's waist. Adjustable belt 410 has an annular shape that conforms to the user's waist and includes inner surface that defines an inner space. Adjustable belt 410 also include smart material 404, examples of which are provided above.

A pair of adjustable leg straps 430, 440 are connected to adjustable belt 410 via straps 436, 446. Buckles 432, 442 and adjustment straps 434, 444 cooperate to tighten adjustable leg straps 430, 440 around the user's legs. Adjustable leg straps 430, 440 also include smart material 438, 448.

In one example, a pair of adjustable shoulder straps 460, 470 may be connected to adjustable belt 410 to provide additional support. Adjustable shoulder straps 460, 470 also include smart material.

Sensor module 450 is coupled to smart material 404, 438, 439, and a power supply, such as a battery. In one example, sensor module 450 includes a tension sensor (not shown) to measure the tension of a repelling rope or line 452. Based on the tension sensor data, sensor module 450 activates or deactivates smart material 404, 438, 439 to tighten or loosen the adjustable belt 410, and adjustable leg straps 430, 440, respectively.

In another example, sensor module 450 includes an accelerometer to measure sudden accelerations produced by, for example, free falls, collisions, etc. In this example, based on the accelerometer data, sensor module 450 activates smart material 404, 438, 439 to tighten the adjustable belt 410, and adjustable leg straps 430, 440, respectively, to create a protective cage to absorb undesired impacts.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A haptic system, comprising:
a haptic safety harness worn by a user, including:
an adjustable belt including a plurality of first magnets; and
a haptic support structure, coupled to the haptic safety harness, including;
an upper platform including a plurality of first electromagnets, the upper platform having an annular shape that defines an inner space in which the haptic safety harness is disposed,
a lower platform, coupled to the upper platform by a plurality of support members, on which the user stands, and
a communication interface, coupled to the plurality of first electromagnets, configured to receive a first haptic control signal from a computer and transmit the first haptic control signal to the plurality of first electromagnets, the first haptic control signal being configured to render a first haptic effect to the user by generating a first magnetic field that interacts with the plurality of first magnets.

2. The haptic system according to claim 1, wherein the first haptic effect is a vibratory haptic effect.

3. The haptic system according to claim 1, wherein the first haptic effect is a force feedback haptic effect.

4. The haptic system according to claim 1, wherein the first magnetic field is generated by a subset of the plurality of first electromagnets.

5. The haptic system according to claim 1, wherein the first magnetic field is a rotating magnetic field.

6. The haptic system according to claim 1, wherein:
the adjustable belt includes a plurality of second magnets oriented perpendicular to the plurality of first magnets,
the upper platform includes a plurality of second electromagnets oriented perpendicular to the plurality of first electromagnets, and
the communications interface is further configured to receive a second haptic control signal and transmit the second haptic control signal to the plurality of second electromagnets, the second haptic control signal being configured to render a second haptic effect to the user by generating a second magnetic field that interacts with the plurality of second magnets.

7. The haptic system according to claim 6, wherein the second magnetic field is generated by a subset of the plurality of second electromagnets.

8. The haptic system according to claim 6, wherein the second magnetic field is a rotating magnetic field.

9. The haptic system according to claim 6, wherein the first haptic control signal and the second haptic control signal are configured to simultaneously render the first haptic effect and the second haptic effect by simultaneously generating the first magnetic field and the second magnetic field.

10. The haptic system according to claim 9, wherein the first haptic control signal renders a vibratory haptic effect and the second haptic control signal renders a force feedback haptic effect.

11. The haptic system according to claim 6, wherein the haptic support structure is coupled to the haptic safety harness by a mechanical coupling that provides a first air gap between the plurality of first magnets and the plurality of first electromagnets and a second air gap between the plurality of second magnets and the plurality of second electromagnets.

12. The haptic system according to claim 6, wherein the haptic support structure is coupled to the haptic safety harness by a magnetic repulsion coupling created by the plurality of first magnets and the plurality of first electromagnets, the magnetic repulsion coupling providing an air gap between the adjustable belt and the upper platform.

13. The haptic system according to claim 1, wherein each support member includes an actuator configured to move the upper platform with respect to the lower platform.

14. The haptic system according to claim 13, wherein the haptic system is an omnidirectional virtual reality treadmill.

15. The haptic system according to claim 1, further comprising:
a communication interface configured to receive a safety control signal,
wherein the adjustable belt includes smart material coupled to the communication interface, and
wherein the safety control signal is configured to activate the smart material to reduce a magnitude of the first haptic effect rendered to the user.

16. A haptic safety harness worn by a user, comprising:
an adjustable belt including a plurality of first magnets, the plurality of first magnets configured to interact with a first magnetic field generated by a plurality of first electromagnets to render a haptic effect to the user.

17. The haptic safety harness according to claim 16, wherein the adjustable belt includes:
a plurality of second magnets oriented perpendicular to the plurality of first magnets, the plurality of second magnets configured to interact with a second magnetic field generated by a plurality of second electromagnets oriented perpendicular to the plurality of first electromagnets to render an additional haptic effect to the user.

18. The haptic safety harness according to claim 16, further comprising:
a communication module configured to receive a safety control signal,
wherein the adjustable belt includes smart material coupled to the communication module, and
wherein the safety control signal is configured to activate the smart material to reduce a magnitude of the haptic effect rendered to the user.

19. A safety harness worn by a user, comprising:
an adjustable belt including smart material;
a first adjustable leg strap, connected to the adjustable belt, including smart material;
a second adjustable leg strap, connected to the adjustable belt, including smart material;
a sensor module, coupled to the smart material in the adjustable belt, the first adjustable leg strap and the second adjustable leg strap, configured to:
measure a tension of a line, and
tighten or loosen the adjustable belt, the first adjustable leg strap, and the second adjustable leg strap based on the tension of the line by activating or deactivating the smart material in the adjustable belt, the first adjustable leg strap and the second adjustable leg strap, respectively.

20. The safety harness according to claim 19, further comprising:
an adjustable shoulder harness, coupled to the adjustable belt, including smart material coupled to the sensor module.
